(19) United States
(12) Patent Application Publication
(10) Pub. No.: US 2022/0063803 A1
(43) Pub. Date: Mar. 3, 2022

(54) Personal Aircraft Assembly

(71) Applicant: Teresa Dixon, Montgomery, AL (US)

(72) Inventor: Teresa Dixon, Montgomery, AL (US)

(21) Appl. No.: 17/011,025

(22) Filed: Sep. 3, 2020

(51) Int. Cl. B64C 39/02; B64D 27/16; B64D 37/04; B64C 13/04; B64C 25/36; B64C 25/44; B64C 13/50; B64C 13/30; B64D 41/00

(52) U.S. Cl. CPC B64C 39/02; B64D 27/16; B64D 37/04; B64C 13/0421; B64D 41/00; B64C 25/44; B64C 13/50; B64C 13/30; B64C 25/36

(57) ABSTRACT

A personal aircraft assembly includes a carriage that can have a driver positioned therein. A plurality of jet packs is each coupled to the carriage for producing thrust to facilitate low altitude flight. Each of the jet packs has an exhaust nozzle pivotally coupled thereto and the exhaust nozzle on each of the jet packs is directed downwardly for lifting the carriage. A fuel tank is coupled to the carriage and the fuel tank is in fluid communication with each of the jet packs to supply fuel to the jet packs. A control stick is movably coupled to the carriage and the control stick is in communication with each of the jet packs. The control stick communicates control commands to the jet packs to facilitate flight control for the driver.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to aircraft devices and more particularly pertains to a new aircraft device for facilitating low altitude flight.

### (2) Description of Related Art Including Information Disclosed Under 37 CFR 1.97 and 1.98

The prior art relates to aircraft devices including a variety of vertical take-off platforms that a driver can stand upon for low altitude flight. The prior art discloses a wearable jet pack that is worn on a pilot for low altitude flight. The prior art discloses a flight platform which includes a plurality of jet nozzles for accomplishing low altitude flight. The prior art also discloses a flight platform that includes a single jet engine being integrated therein for low altitude flight. The prior art discloses a hover craft that includes a saddle and a fan that lifts the saddle.

### BRIEF SUMMARY OF THE INVENTION

An embodiment of the disclosure meets the needs presented above by generally comprising a carriage that can have a driver positioned therein. A plurality of jet packs is each coupled to the carriage for producing thrust to facilitate low altitude flight. Each of the jet packs has an exhaust nozzle pivotally coupled thereto and the exhaust nozzle on each of the jet packs is directed downwardly for lifting the carriage. A fuel tank is coupled to the carriage and the fuel tank is in fluid communication with each of the jet packs to supply fuel to the jet packs. A control stick is movably coupled to the carriage and the control stick is in communication with each of the jet packs. The control stick communicates control commands to the jet packs to facilitate flight control for the driver.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of a personal aircraft assembly according to an embodiment of the disclosure.

FIG. 2 is a back view of an embodiment of the disclosure.

FIG. 3 is a front view of an embodiment of the disclosure.

FIG. 4 is a top view of an embodiment of the disclosure.

FIG. 5 is a bottom view of an embodiment of the disclosure.

FIG. 6 is a detail view taken from circle 6 of FIG. 1 of an embodiment of the disclosure.

FIG. 7 is a detail view taken from circle 7 of FIG. 1 of an embodiment of the disclosure.

FIG. 8 is a schematic view of an embodiment of the disclosure.

### DETAILED DESCRIPTION OF THE INVENTION

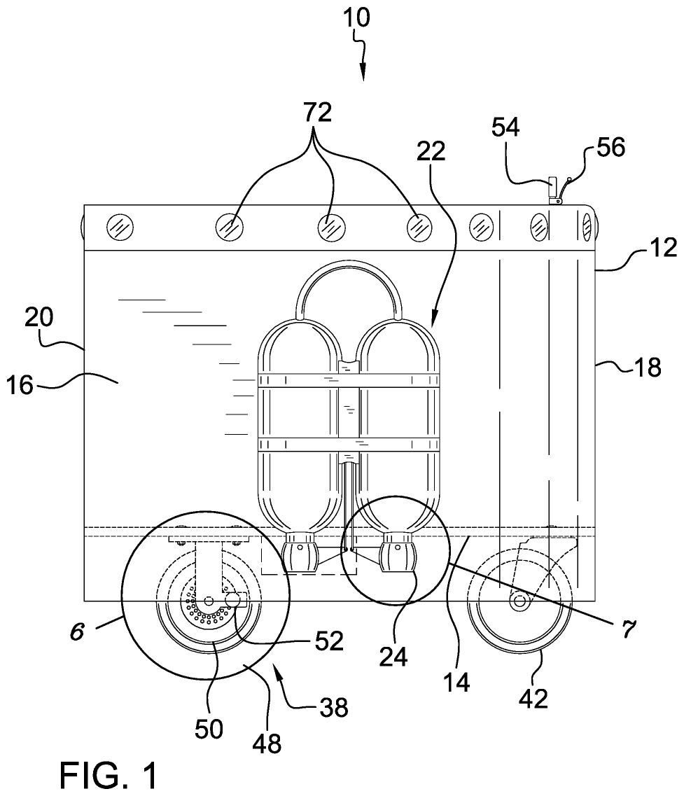

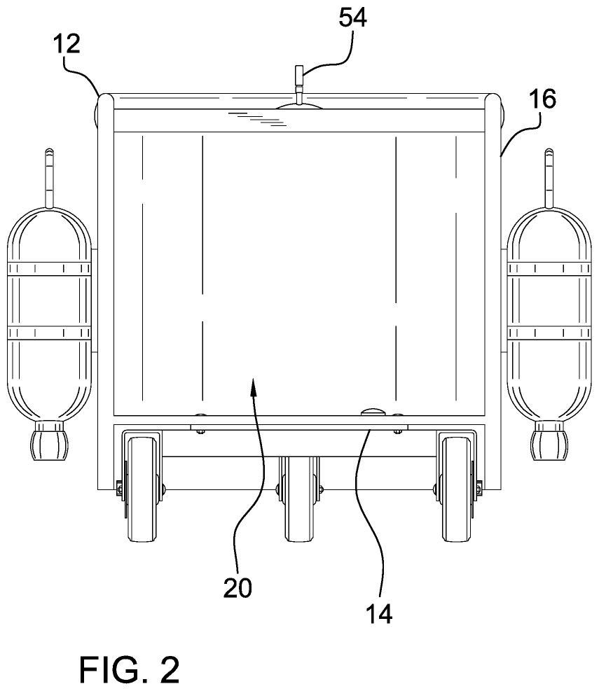

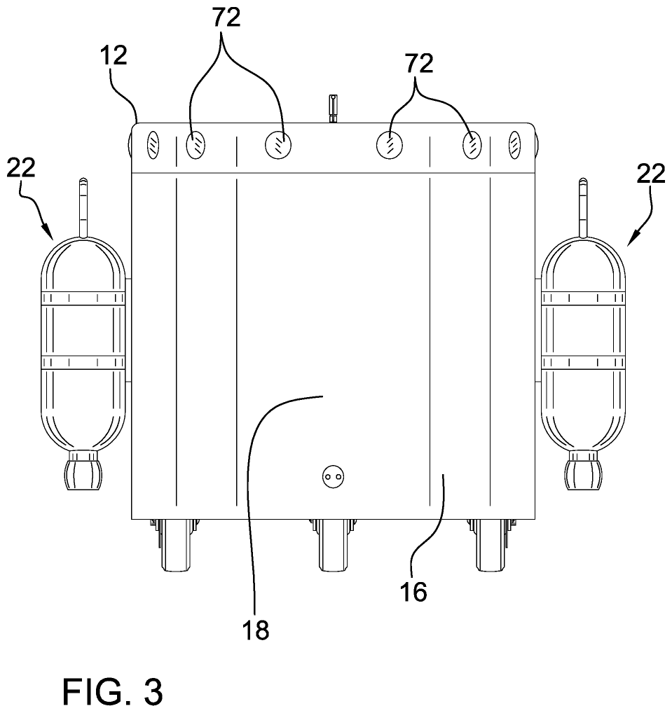

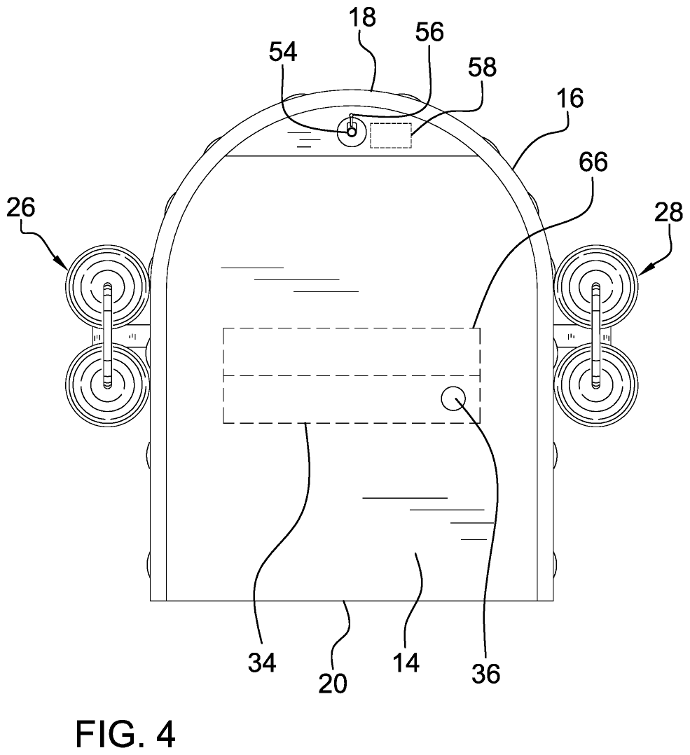

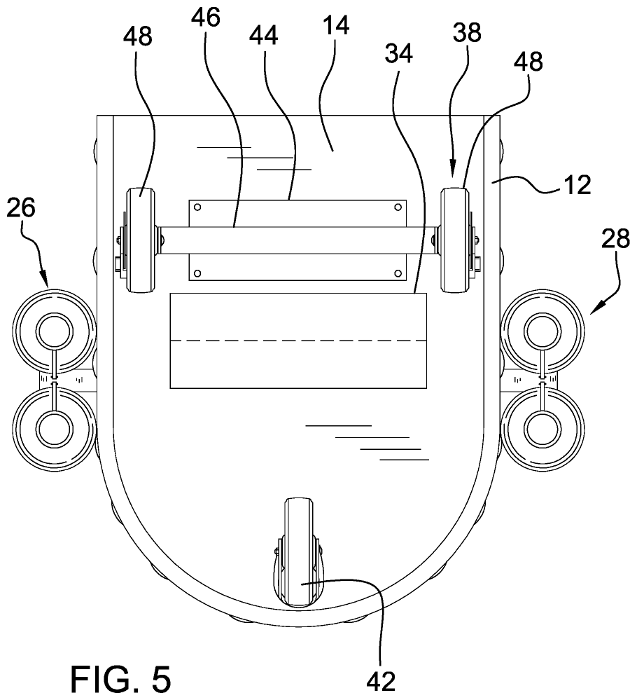

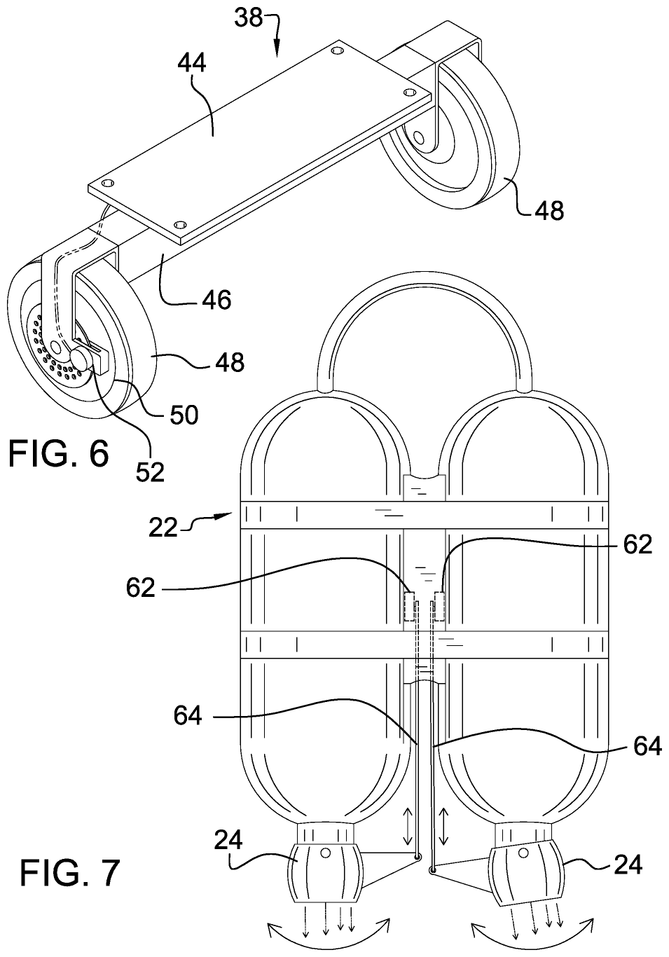

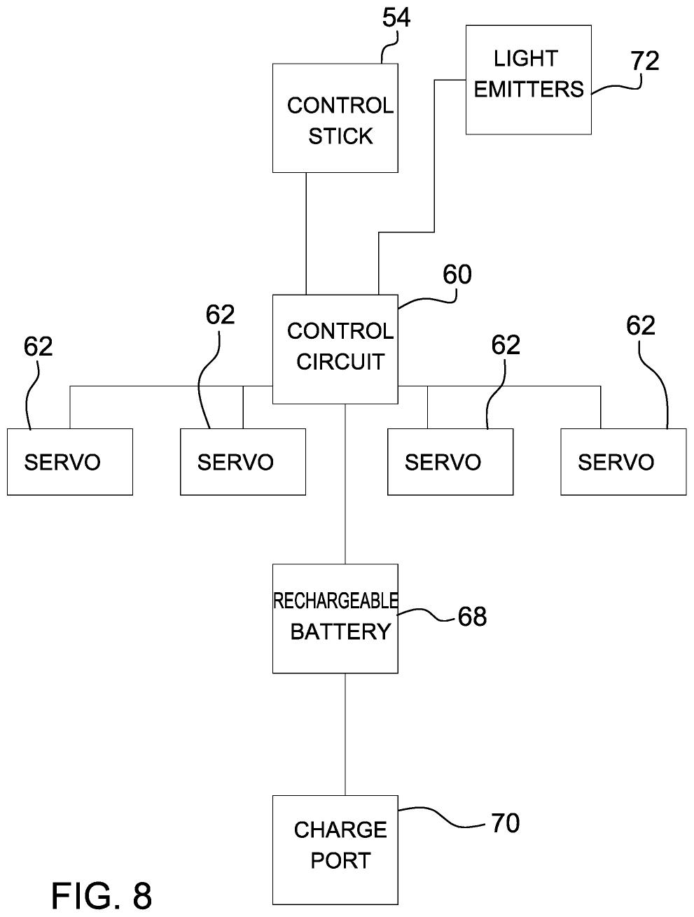

With reference now to the drawings, and in particular to FIGS. 1 through 8 thereof, a new aircraft device embodying the principles and concepts of an embodiment of the disclosure and generally designated by the reference numeral 10 will be described.

As best illustrated in FIGS. 1 through 8, the personal aircraft assembly 10 generally comprises a carriage 12 that can have a driver positioned therein. The carriage 12 has a bottom wall 14 and an outer wall 16 extending upwardly therefrom. The outer wall 16 has a front side 18 and a back side 20, the back side 20 is open to access an interior of the carriage 12 and the front side 18 curves outwardly from the back side 20. A plurality of jet packs 22 is provided and each of the jet packs 22 is coupled to the carriage 12. Each of the jet packs 22 produces thrust when the jet packs 22 are turned on to facilitate low altitude flight. Each of the jet packs 22 has an exhaust nozzle 24 that is pivotally coupled thereto. The exhaust nozzle 24 on each of the jet packs 22 is directed downwardly thereby facilitating the exhaust nozzle 24 to direct exhaust downwardly for lifting the carriage 12.

The plurality of jet packs 22 includes a set of first jet packs 26 and a set of second jet packs 28. Each of the first jet packs 26 is positioned on a first lateral side 30 of the outer wall 16 of the carriage 12 and each of the second jet packs 28 is positioned on a second lateral side 32 of the outer wall 16. Each of the jet packs 22 may comprise a liquid fuel jet pack or the like that has a maximum thrust of approximately 300.0 lbs. A fuel tank 34 is coupled to the carriage 12 and the fuel tank 34 contains fuel for the jet packs 22. The fuel tank 34 is in fluid communication with each of the jet packs 22 to supply the fuel to the jet packs 22, and the fuel tank 34 has a fill port 36.

A set of landing gear 38 is rotatably coupled to the carriage 12 such that the landing gear 38 can roll along a support surface 40. The landing gear 38 comprises a front wheel 42 that is rotatably coupled to the bottom wall 14 of the carriage 12 for rolling along the support surface 40. The front wheel 42 is pivotable about a vertical axis for steering the carriage 12 and the front wheel 42 is centrally positioned along the front side 18 of the outer wall 16 of the carriage 12. The landing gear 38 includes a plate 44 that is coupled to the bottom wall 14 of the carriage 12. The plate 44 is positioned adjacent to the back side 20 of the outer wall 16 of the carriage 12 and the plate 44 is oriented to extend along a line is oriented parallel to the back side 20.

The landing gear 38 includes a cross member 46 that is coupled to the plate 44. The cross member 46 extends along the line oriented parallel to the back side 20. The landing gear 38 includes a pair of rear wheels 48 that is each rotatably coupled to and extends downwardly from the cross member 46. Each of the rear wheels 48 is positioned on opposite sides of the cross member 46s and each of the rear wheels 48 rolls along the support surface 40. The landing gear 38 includes a pair of brake rotors 50 that is each coupled to a respective one of the rear wheels 48. The landing gear 38 includes a pair of brake calipers 52 that each engages a respective one of the brake rotors 50 for braking the carriage 12. Each of the brake calipers 52 may comprise hydraulic brake calipers or the like.

A control stick 54 is movably coupled to the carriage 12 and the control stick 54 is manipulated by the driver. A brake lever 56 is movably coupled to the control stick 54 and the brake lever 56 is in communication with the brake calipers 52. Each of the brake calipers 52 engages the respective brake rotor 50 when the brake lever 56 is manipulated into a braking position. A control unit 58 is coupled to the carriage 12 and the control unit 58 is in communication with each of the jet packs 22. Additionally, the control unit 58 is in communication with the control stick 54 thereby facilitating the control unit 58 to communicate control commands from the control stick 54 to the jet packs 22. In this way the control unit 58 facilitates flight control for the driver.

The control unit 58 comprises a control circuit 60 that is coupled to the carriage 12 and the control stick 54 is electrically coupled to the control unit 58. The control circuit 60 may include circuitry common to flight control computers and other types of avionics that might be employed to control jet packs 22. The control unit 58 includes a plurality of servos 62 that is each coupled to a respective one of the jet packs 22. Each of the servos 62 is electrically coupled to the control circuit 60 and each of the servos 62 is actuated in accordance with the control commands received from the control stick 54. Each of the servos 62 may comprise an electromechanical servo or other appropriate mechanism for accomplishing flight controls.

The control unit 58 includes a plurality of linkages 64 that is each of the linkages 64 is coupled between a respective one of the servos 62 and the exhaust nozzle 24 on a respective one of the jet packs 22. In this way the respective servo can move the exhaust nozzle 24 on the respective jet pack. Thus, the exhaust nozzle 24 on each of the jet packs 22 can direct the thrust in appropriate directions to accomplish flight control.

A power supply 66 is coupled to the carriage 12 and the power supply 66 is electrically coupled to the control circuit 60. The power supply 66 comprises a rechargeable battery 68 that is coupled to the carriage 12 and the rechargeable battery 68 is electrically coupled to the control circuit 60. The power supply 66 includes charge port 70 that is coupled to the carriage 12 and the charge port 70 can be electrically coupled to a power source, such as a battery charger or the like. The charge port 70 is electrically coupled to the rechargeable battery 68 for charging the rechargeable battery 68. A plurality of light emitters 72 is each coupled to the outer wall 16 of the carriage 12 for emitting light outwardly therefrom. The light emitters 72 are spaced apart from each other and are distributed around a full perimeter of said outer wall 16. Each of the light emitters 72 is electrically coupled to the control circuit 60 and a power switch may be provided for turning the light emitters 72 on and off.

In use, the driver manipulates the control stick 54 in order to fly the carriage 12 over a desired distance. In this way a physically disabled user can easily cross terrain that would otherwise be impassible for the physically disabled user. The jet packs 22 can additionally be directed to urge the carriage 12 to roll along the support surface 40 on the landing gear 38. The brake handle can be squeezed in order to brake the carriage 12 while the carriage 12 is rolling on the landing gear 38.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A personal aircraft assembly for facilitating low altitude flight, said assembly comprising:
a carriage being configured to have a driver positioned therein;
a plurality of jet packs, each of said jet packs being coupled to said carriage, each of said jet packs producing thrust when said jet packs are turned on wherein said carriage is configured to facilitate low altitude flight, each of said jet packs having an exhaust nozzle being pivotally coupled thereto, said exhaust nozzle on each of said jet packs being directed downwardly wherein said exhaust nozzle is configured to direct exhaust downwardly for lifting said carriage;
a fuel tank being coupled to said carriage wherein said fuel tank is configured to contain fuel, said fuel tank being in fluid communication with each of said jet packs wherein said fuel tank is configured to supply the fuel to said jet packs, said fuel tank having a fill port;
a set of landing gear being rotatably coupled to said carriage wherein said landing gear is configured to roll along a support surface;
a control stick being movably coupled to said carriage wherein said control stick is configured to be manipulated by the driver;
a control unit being coupled to said carriage, said control unit being in communication with each of said jet packs, said control unit being in communication with said control stick thereby facilitating said control unit to communicate control commands from said control stick to said jet packs wherein said control unit is configured to facilitate flight control for the driver.

2. The assembly according to claim 1, wherein:
said carriage has a bottom wall and an outer wall extending upwardly therefrom, said outer wall having a back side, said back side being open to access an interior of said carriage; and
said plurality of jet packs includes a set of first jet packs and a set of second jet packs, each of said first jet packs being positioned on a first lateral side of said outer wall of said carriage, each of said second jet packs being positioned on a second lateral side of said outer wall.

3. The assembly according to claim 2, wherein said landing gear comprises a front wheel being rotatably coupled to said bottom wall of said carriage wherein said front wheel is configured to roll along the support surface, said front wheel being pivotable about a vertical axis for steering said carriage.

4. The assembly according to claim 2, wherein said landing gear comprises:
a plate being coupled to said bottom wall of said carriage, said plate being positioned adjacent to said back side of said outer wall of said carriage, said plate being oriented to extend along a line being oriented parallel to said back side; and
a cross member being coupled to said plate, said cross member extending along said line oriented parallel to said back side.

5. The assembly according to claim 4, wherein said landing gear comprises a pair of rear wheels, each of said rear wheels being rotatably coupled to and extending downwardly from said cross member, each of said rear wheels being positioned on opposite sides of said cross members wherein each of said rear wheels is configured to roll along the support surface.

6. The assembly according to claim 5, wherein said landing gear comprises:
a pair of brake rotors, each of said brake rotors being coupled to a respective one of said rear wheels; and
a pair of brake calipers, each of said brake calipers engaging a respective one of said brake rotors for braking said carriage.

7. The assembly according to claim 1, wherein said control unit comprises a control circuit being coupled to said carriage, said control stick being electrically coupled to said control unit.

8. The assembly according to claim 7, wherein said control unit includes a plurality of servos, each of said servos being coupled to a respective one of said jet packs, each of said servos being electrically coupled to said control circuit, each of said servos being actuated in accordance with the control commands received from said control stick.

9. The assembly according to claim 8, wherein said control unit includes a plurality of linkages, each of said linkages being coupled between a respective one of said servos and said exhaust nozzle on a respective one of said jet packs thereby facilitating said respective servo to move said exhaust nozzle on said respective jet pack.

10. The assembly according to claim 7, further comprising a power supply being coupled to said carriage, said power supply being electrically coupled to said control circuit, said power supply comprising:
a rechargeable battery being coupled to said carriage, said rechargeable battery being electrically coupled to said control circuit; and
a charge port being coupled to said carriage wherein said charge port is configured to be electrically coupled to a power source, said charge port being electrically coupled to said rechargeable battery for charging said rechargeable battery.

11. A personal aircraft assembly for facilitating low altitude flight, said assembly comprising:
a carriage being configured to have a driver positioned therein, said carriage having a bottom wall and an outer wall extending upwardly therefrom, said outer wall having a back side, said back side being open to access an interior of said carriage;
a plurality of jet packs, each of said jet packs being coupled to said carriage, each of said jet packs producing thrust when said jet packs are turned on wherein said carriage is configured to facilitate low altitude flight, each of said jet packs having an exhaust nozzle being pivotally coupled thereto, said exhaust nozzle on each of said jet packs being directed downwardly wherein said exhaust nozzle is configured to direct exhaust downwardly for lifting said carriage, said plurality of jet packs including a set of first jet packs and a set of second jet packs, each of said first jet packs being positioned on a first lateral side of said outer wall of said carriage, each of said second jet packs being positioned on a second lateral side of said outer wall;
a fuel tank being coupled to said carriage wherein said fuel tank is configured to contain fuel, said fuel tank being in fluid communication with each of said jet packs wherein said fuel tank is configured to supply the fuel to said jet packs, said fuel tank having a fill port;
a set of landing gear being rotatably coupled to said carriage wherein said landing gear is configured to roll along a support surface, said landing gear comprising:
a front wheel being rotatably coupled to said bottom wall of said carriage wherein said front wheel is configured to roll along the support surface, said front wheel being pivotable about a vertical axis for steering said carriage;
a plate being coupled to said bottom wall of said carriage, said plate being positioned adjacent to said back side of said outer wall of said carriage, said plate being oriented to extend along a line being oriented parallel to said back side;
a cross member being coupled to said plate, said cross member extending along said line oriented parallel to said back side;
a pair of rear wheels, each of said rear wheels being rotatably coupled to and extending downwardly from said cross member, each of said rear wheels being positioned on opposite sides of said cross members wherein each of said rear wheels is configured to roll along the support surface;
a pair of brake rotors, each of said brake rotors being coupled to a respective one of said rear wheels; and
a pair of brake calipers, each of said brake calipers engaging a respective one of said brake rotors for braking said carriage;
a control stick being movably coupled to said carriage wherein said control stick is configured to be manipulated by the driver;
a control unit being coupled to said carriage, said control unit being in communication with each of said jet packs, said control unit being in communication with said control stick thereby facilitating said control unit to communicate control commands from said control stick to said jet packs wherein said control unit is configured to facilitate flight control for the driver, said control unit comprising:
a control circuit being coupled to said carriage, said control stick being electrically coupled to said control unit;
a plurality of servos, each of said servos being coupled to a respective one of said jet packs, each of said servos being electrically coupled to said control circuit, each of said servos being actuated in accordance with the control commands received from said control stick;
a plurality of linkages, each of said linkages being coupled between a respective one of said servos and said exhaust nozzle on a respective one of said jet packs thereby facilitating said respective servo to move said exhaust nozzle on said respective jet pack; and
a power supply being coupled to said carriage, said power supply being electrically coupled to said control circuit, said power supply comprising:
a rechargeable battery being coupled to said carriage, said rechargeable battery being electrically coupled to said control circuit; and
a charge port being coupled to said carriage wherein said charge port is configured to be electrically coupled to a power source, said charge port being electrically coupled to said rechargeable battery for charging said rechargeable battery.
